(19) United States
(12) Patent Application Publication
(10) Pub. No.: US 2013/0113614 A1
(43) Pub. Date: May 9, 2013

(54) SYSTEMS AND METHODS FOR VEHICLE DOOR CLEARANCE ZONE PROJECTION

(71) Applicant: Wilford Trent Yopp, Canton, MI (US)

(72) Inventor: Wilford Trent Yopp, Canton, MI (US)

(73) Assignee: FORD GLOBAL TECHNOLOGIES, LLC, DEARBORN, MI (US)

(21) Appl. No.: 13/288,070

(22) Filed: Nov. 3, 2011

(51) Int. Cl. B60Q 1/00

(52) U.S. Cl. 340/438

(57) ABSTRACT

A system and associated method for detecting an obstacle in a door clearance zone and warning vehicle occupants about the obstacle. The system includes sensors for generating signals for detecting an obstacle, and a controller for processing the signals. The controller provides an indication that an obstacle has been detected in a door clearance zone, either by feeding data to a visual display that includes an image of the vehicle and to door clearance zone, or by an audible signal. The method includes generating sensor signals and processing those signals to detect an obstacle within a door clearance zone. A visual display may be provided, in which case the method further includes projecting an image of the vehicle, one or more door clearance zones, and any detected obstacle. Further, a warning may be actuated to indicate detection of an obstacle, as an audible signal or a visual indication.

### TECHNICAL FIELD

The present disclosure in general relates to vehicle safety measures, and in particular relates to vehicle environment visualization.

### BACKGROUND

Conventionally, vehicles employ monitoring systems to aid the driver in avoiding obstacles, such as objects in close proximity to the vehicle. These systems may be based on ultrasonic, radar, laser, or vision technologies for various applications such as aiding parking and reversing, lane departure, lane-keeping and adaptive cruise control.

A vehicle environment monitoring system usually consists of one or more sensors, at least one display, and a controller. The sensors are placed at appropriate locations on the vehicle. The display is usually disposed where the driver can see it. The controller processes data received from the sensors and presents that data on the display screen. Optionally, the controller also actuates an alarm when the data indicate a predefined emergency condition. The display screen is necessarily somewhat small, however, and the images displayed there can be difficult to see in any detail. Moreover, the images are often not true to scale, given the generally wide-angle optics employed. While these displays do provide information for what objects are present around the vehicle, the occupants of the vehicle must estimate some distances such as door opening clearance. Such estimates are by necessity difficult.

Door clearance is an important parameter for facilitating comfortable entry into and exit from the vehicle. In addition, some persons, such as elderly or disabled persons, require a relatively large “door clearance”, in comparison to the clearance required for a child, for example. Also, a vehicle equipped with a single door on the side of a vehicle generally requires a larger door clearance than a vehicle equipped with two doors per side. Further, inclement weather, such as snow, can blur or obliterate parking lines, making it all the more difficult to estimate the door clearance zone.

Thus, there is a need for a vehicle environment visualization system that not only detects the door clearance zone but also actuates an alarm in case of an emergency.

### SUMMARY

To overcome the aforesaid challenges, the present disclosure proposes a vehicle environment estimation and visualization system. Instead of the driver having to estimate the door opening clearance around the vehicle, the system projects a door opening clearance zone around the vehicle.

One aspect of the disclosure presents a vehicle door clearance zone projection system. That system includes one or more sensors configured to provide sensor output signals indicative of a distance between the sensors and any nearby object. Signals from the sensors are processed by a controller, operatively coupled to the sensors and employing stored data describing the clearance around the vehicle required for the vehicle doors. The controller receives receive the sensor output signals and from them it determines whether a detected nearby object lies within a predetermined door clearance zone. If an object is detected with the door clearance zone, the controller actuates an alarm.

Another aspect of the disclosure presents a vehicle door clearance zone projection system. That system includes one or more sensors configured to provide sensor output signals indicative of a distance between the sensors and any nearby object. Signals from the sensors are processed by a controller, operatively coupled to the sensors and employing stored data describing the clearance around the vehicle required for the vehicle doors. The controller receives receive the sensor output signals and from them it determines whether a detected nearby object lies within a predetermined door clearance zone, and it convert the sensor output signals into controller output signals adapted to serve as input to a visual display. The visual display receives the visual display signals and projects a door clearance zone lying at a predetermined distance from the vehicle, onto the visual display.

Yet another aspect of the disclosure is a method for detecting an obstacle within a vehicle door clearance zone. That method begins by generating a detection signal using one or more sensors, and those signals employ the detection signal to capture the vehicle environment data. That data is sent to a controller, which selects a preset value for the door clearance zone. The controller then analyzes the captured data to determine whether an obstacle lies in the door clearance zone, and it actuates an alarm upon detecting an obstacle in the door clearance zone.

These and other features, aspects, and advantages of the present disclosure will be better understood with reference to the following description and appended claims. The summary has been provided to introduce a selection of concepts in a simplified form. The summary is not intended to identify key features or essential features of the present disclosure, nor is it intended to limit the scope of the present invention and appended claims.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a schematic elevation view of an embodiment of the vehicle door clearance system in accordance with the present disclosure.

FIG. 2 is a schematic top view of an embodiment of the vehicle door clearance system of FIG. 1.

FIG. 3 is a schematic illustration of an embodiment of the display, in accordance with the present disclosure.

FIG. 4 is a logic flow diagram of an embodiment of the vehicle door clearance system, illustrating a method of performing door clearance zone detection, in accordance with the present disclosure.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure described a vehicle door clearance zone projection system with a warning mechanism for vehicle occupants. To this end, the system includes one or more sensors and a controller. The one or more sensors provide output signals indicative of a distance between the one or more sensors and a nearby object. The controller is coupled with the one or more sensors, receives the sensor output signals, determines whether a detected nearby object lies within a predetermined door clearance zone, and actuates an alarm upon detecting an object within the door clearance zone. In addition, the controller may include stored data related to the clearance required for vehicle doors.

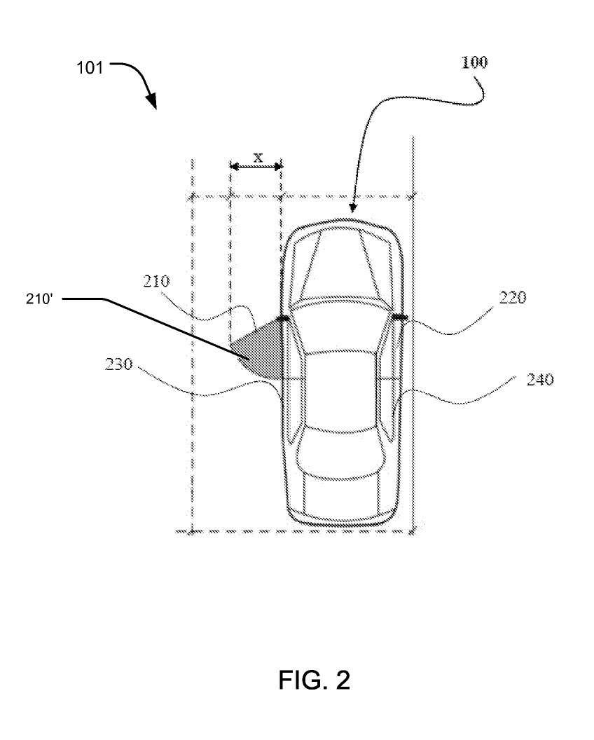

As used herein, the term “door clearance zone” describes the space swept by a vehicle door during opening and closing. A vehicle thus has one door clearance zone for each door. This term is illustrated in FIG. 2, where a door clearance zone 210′ can be seen.

### Exemplary embodiments

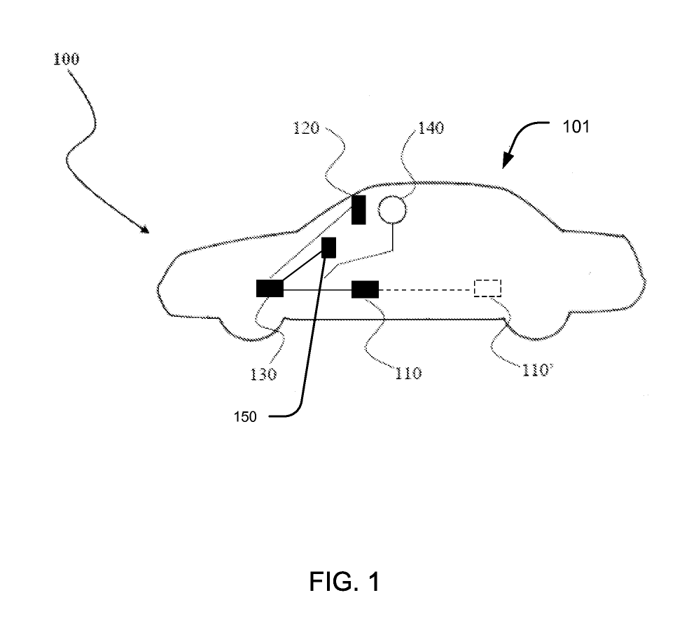

FIG. 1 is an overall schematic view of a vehicle including a door clearance zone projection system (the “system”) 100 according to an embodiment of the present disclosure. The system 100 warns users about objects lying within door clearance zones adjacent to the vehicle. The system includes one or more sensors 110, 110′, a visual display 120, and a controller 130. Optionally, the system may also include an audio alert device 150. The vehicle door clearance zone projection system may be OEM equipment (integral to the vehicle as manufactured) or installed as after-market equipment.

The sensors 110, 110′ are disposed at various locations of the vehicle, designed to capture' data sufficient to warn users about objects lying within the vehicle's door clearance zones. In general, sensors 110, 110′ fall into two broad categories. In one embodiment, sensors provide a visual picture of the vehicle's surroundings, either in part or in full. In such systems, the sensors are cameras, positioned to provide a view of the entire area around a vehicle, or a critical portion of that area. Cameras can be video devices, still cameras, or high definition cameras. Conventional back-up assist systems employ such sensors or cameras.

Alternatively, sensors can provide only warning information regarding the proximity of an obstacle. For example, a sensor 100 could be an ultrasonic device providing data indicating an obstacle, either by distance or direction, or both. A range of technologies can be adapted for such sensors, including ultrasound, radar, or lasers.

In either event, the sensors 110, 110′ may be stationary or may rotate in various directions to sweep desired areas around the vehicle. For example, in one embodiment of the present disclosure, the sensors 110, 110′ may be mounted on, or actuated by, motorized rotating mechanisms, such as stepper motors, to actuate the desired movement. Multiple rotational means may be provided to rotate a sensor in multiple directions. One embodiment features rotation on two axes, one back and forth in a direction parallel to the vehicle's longitudinal axis, and the other up and down. Designers will be capable of identifying the areas desired to be swept and appropriate mechanisms for actuating the sensors to perform that task. Alternative technologies for implementing the sensors 110, 110′ include radar and laser devices. If a visual system is employed, the camera device could be positioned high on the vehicle, and wide-angle lenses could minimize the need for camera movement.

The sensors 110, 110″ transmit sensor signals to the controller 130. This device can be a microprocessor-based controller having capability for inputs and outputs, as well as a communication bus, storage capacity, such as RAM or ROM, and some degree of processing capability. The controller 130 may be a stand-alone controller independent from the vehicle's power-train control module (PCM) or it may be integrated with the PCM system. In another embodiment, the controller 130 is in communication with Electronic Control Module (ECM).

The controller 130 outputs visual display signals to visual display 120. That display can be a screen-based display such as an LCD, LED, or CRT display, or it may be implemented as a Head's Up Display (HUD) overlaying the forward vision of the driver 140 through the vehicle windshield. Any other known display mechanisms are also contemplated by the present disclosure. Operation details of the visual display 120 are set out in detail below.

Some embodiments add an audio alert device 150. That device functions as an alarm, actuated by controller 130. In such embodiments, the system goes beyond merely displaying an obstacle within a door clearance zone, to actively warn the user that a danger condition exists. The audio alert device 150, for example, may indicate a danger condition by sounding a pre-recorded warning or a siren or a combination thereof

Referring to FIG. 2, which is a schematic top view of an embodiment of the vehicle door clearance system of FIG. 1. The vehicle illustrated there has four doors 210, 220, 230 and 240. As shown, door 210 is fully opened, and doors 220, 230 and 240 closed. The door clearance zone 210′ is the shaded area swept by door 210 when opening or closing. Similarly, doors 220, 230, 240 have their respective “door clearance zones”. The doors may be of any type know or used in the art, operated manually or powered electronically. The doors may rotate vertically upward or may swing horizontally outward from the body of the car. The illustrated vehicle includes four doors, but other embodiments having two or three doors are known, as are further embodiments in which a rear door or hatchback is provided. As shown, the door clearance zone lying at a predetermined distance (x), from the vehicle.

The location of all door clearance zones for a given vehicle is stored in controller 130. For a given vehicle, the location and extent of door clearance zones will not vary over time. Thus, controller 130 can completely store the locations of all door clearance zones 210, along with the data required to generate an image of the vehicle 101. Further details of controller 130 and the associated data are set out below.

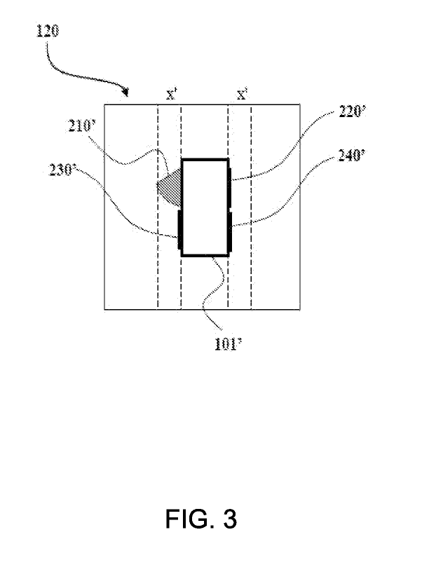

FIG. 3 is a schematic illustration of the visual display 120, according to an embodiment of the present disclosure. As shown, an image 101′ is formed on the visual display 120 that indicates the vehicle 101. Images 210′, 220′, 230′, and 240′ indicate the doors 210, 220, 230, and 240 respectively. A door clearance zone is projected on the visual display 120, as shown by the shaded arc. The area covered by the door clearance zone is indicated as (X′, as shown. The images formed on the visual display 120, including the shaded arc, may be displayed as icons similar to the reference vehicle 101, or may be a simplified indicator such as merely a circle or square or triangle and the like. It will be recognized that only a single door clearance zone 210′ is shown, in the interest of clarity. Other door clearance zones 210′ could be generated and displayed as well. It will be further recognized that the displayed image 101′ can be generated in relatively schematic form, as illustrated, or in considerably more graphic detail. Generating a detailed image lies completely within the skill of those in the art, and the decision on the nature of the image to be employed rests primarily on aesthetic and budgetary considerations, rather than technical ones.

The embodiment of the present disclosure are illustrated in FIGS. 1, 2 and 3 includes sensors configured to provide a sensor output signal indicative of the distance between the vehicle and any object or obstruction in the near vicinity of vehicle 101. Sensor output signals are fed to controller 130, which is configured to recognize signals indicating such an object. When an object is detected in the door clearance zone, the controller 130 actuates a sensory alert, in the form of a visual alarm, or audio alarm, or both The visual alarm may be represented some indication on visual display 120, such as blinking the shaded arc of door clearance zone 210′, which may be accomplished in a manner calculated to attract the driver's attention, such as blinking in a bright red light. The door clearance zone may also be colorized to indicate the relative distance of the detected object from the door clearance zone. Thus, if the object is at a safe distance from the door clearance zone then indicative color is green. Other colors may also be used to convey the about an increasing level of danger, such as employing red, yellow and green illumination. Alternatively, the controller 130 may actuate audio alert device 150 to sound some manner of audible alarm signal. Further, both audio and visual alarms can be simultaneously actuated.

In another embodiment of the present disclosure, the system may associate different audible tones for different doors. Thus, for example, an obstruction inside the door clearance zone of the front left hand door would result in a first tone, while obstruction inside door clearance zone of the front right hand door 220 would produce a second tone, and so. The different choices may be preset, or they may be configurable, and differences could be selected as differences in pitch, content, or number of repetitions. Those of ordinary skill in the art will be capable of selecting and implementing this feature as desired.

Although the actual size of door clearance zone 210′ depends solely on the physical characteristics of the vehicle and its various doors, the user may choose to expand the door clearance zone by a given amount under certain circumstances. For example, if an elderly or disabled person will be using the vehicle, the user can choose to employ an augmented door clearance zone. The larger size of the augmented door clearance on allows the system 100 to detect and warn about obstacles that lie beyond the area swept by a given door but which might hinder the movement of a given user. The option to select this feature could be provided in terms of an absolute distance to expand the door clearance zone, or one or two preset expansion levels could be provided. In some embodiments, presets could be provided in a manner similar to the technique employed for driver seat positions, using a key fob or similar device. Those of skill in the art will be capable of providing for selection of a wide range of augmented door clearance zones, as desired.

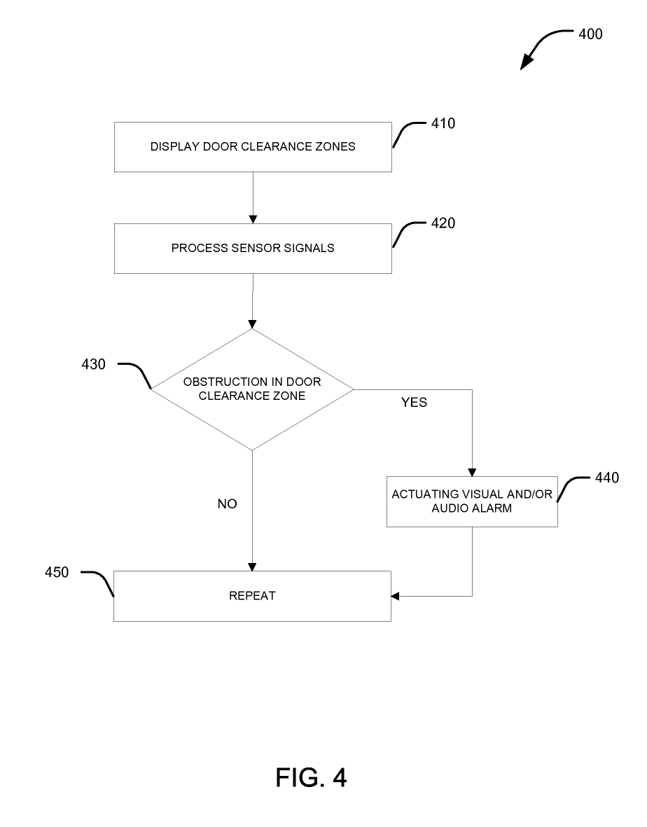

Referring now to FIG. 4, a logic flow diagram illustrates process 400 performing door clearance zone detection according to the present disclosure. Although the following steps are described in connection with the embodiments of FIG. 1, 2 and 3, the steps may be utilized and modified for other embodiments based upon the present disclosure, as will be understood by those having skill in the art. Additionally, it will be understood that the process 400 operates on a completely configured door clearance zone projection system. That is, options such as selecting and configuring an augmented door clearance zone, as described above, are assumed to be complete.

The process 400 begins at step 410, where the system 100 generates an initial display, such as that shown in FIG. 3. Sensors then generate a detection signal, receive any signals indicating the presence of an obstacle, and forward those signals to the controller. That element is configured to receive the captured signal and process it to determine whether any indication of an obstacle is present. Those actions occur at step 420. At step 430, the controller determines whether there is any obstruction inside the selected door clearance zone. If such an obstruction is present, processing proceeds to step 440, where the controller actuates an audio alarm, visual alarm, or both. If no obstruction is present, the “No” routing from the decision block print processing to step 450, which repeats the process. The nature of any alarm sounded or displayed is discussed fully above.

It should be noted that some embodiments of the system could rely solely on an audible alarm. In that event, no visual display 120 (FIG. 1) would be included in the system. Moreover, step 410, displaying the door clearance zones would be omitted as well. In such embodiments, the audible alarm would be triggered upon detecting an obstacle in the door clearance zone (step 440). Otherwise, the system would operate identically to previously-described embodiments.

The specification sets out a number of specific exemplary embodiments, but those skilled in the art will understand that variations in these embodiments will naturally occur in the course of implementing the subject matter of the disclosure in specific environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. A vehicle door clearance zone projection system, the system comprising:
one or more sensors configured to provide sensor output signals indicative of a distance between the one or more sensors and a nearby object;
a controller, operatively coupled to the one or more sensors and having stored data related to the clearance required for vehicle doors, configured to
receive the sensor output signals;
determine whether a detected nearby object lies within a predetermined door clearance zone; and
actuate an alarm upon detecting an object within the door clearance zone.

2. The vehicle door clearance zone projection system of claim 1, further including at least one visual display, configured to:
receive the visual display signals;
convert the sensor output signals into controller output signals adapted to serve as input to the visual display; and
project a door clearance zone, lying at a predetermined distance from the vehicle, onto the visual display.

3. The vehicle door clearance zone projection system of claim 1, wherein the alarm is an audible alarm.

4. The vehicle door clearance zone projection system of claim 1, wherein the alarm is a visual alarm.

5. The vehicle door clearance zone projection system of claim 1, wherein the alarm is a combined audio and visual alarm.

6. The vehicle door clearance zone projection system of claim 1, wherein the sensors are ultrasonic sensors.

7. The vehicle door clearance zone projection system of claim 1, wherein the sensors are laser sensors.

8. The vehicle door clearance zone projection system of claim 1, wherein the sensors are radar sensors.

9. A vehicle door clearance zone projection system, the system comprising:
one or more sensors configured to provide sensor output signals indicative of a distance between the one or more sensors and a nearby object;
a controller, operatively coupled to the one or more sensors and having stored data related to the clearance required for vehicle doors, configured to receive the sensor output signals;
determine whether a detected nearby object lies within a predetermined door clearance zone and
output visual display signals;
at least one visual display, configured to;
receive the visual display signals;
convert the sensor output signals into controller output signals adapted to serve as input to the visual display; and
project a door clearance zone, lying at a predetermined distance from the vehicle, onto the visual display.

10. The vehicle door clearance zone projection system of claim 9, wherein the alarm is an audible alarm.

11. The vehicle door clearance zone projection system of claim 9, wherein the alarm is a visual alarm.

12. The vehicle door clearance zone projection system of claim 9, wherein the alarm is a combined audio and visual alarm.

13. The vehicle door clearance zone projection system of claim 9, wherein the sensors are ultrasonic sensors.

14. The vehicle door clearance zone projection system of claim 9, wherein the sensors are laser sensors.

15. The vehicle door clearance zone projection system of claim 9, wherein the sensors are radar sensors.

16. A method for detecting an obstacle within a vehicle door clearance zone, the method comprising:
generating a detection signal using one or more sensors;
capturing the vehicle environment data employing the detection signal;
sending the captured data to a controller;
selecting a preset value for the door clearance zone;
analyzing the captured data to determine whether an obstacle lies in the door clearance zone; and
actuating an alarm upon detecting an obstacle in the door clearance zone.

17. The method for detecting an obstacle within a vehicle door clearance zone of claim 16, further comprising
displaying an image of the vehicle on a visual display; and
projecting a door clearance zone, lying at a predetermined distance from the vehicle, onto the visual display.

18. The method for detecting an obstacle within a vehicle door clearance zone of claim 16, further comprising
selecting multiple preset values for multiple door clearance zones, each door clearance zone corresponding to the parameters of a vehicle door
displaying an image of the vehicle on a visual display; and
projecting a door clearance zone, lying at a predetermined distance from the vehicle, onto the visual display.

19. The method for detecting a vehicle door clearance zone of claim 17, further including projecting on the visual display an image corresponding to the location of a detected obstacle.

20. The method for detecting a vehicle door clearance zone of claim 18, further including projecting on the visual display one or more images corresponding to the location of one or more detected obstacles.
